(19) United States
(12) Patent Application Publication
(10) Pub. No.: US 2026/0138372 A1
(43) Pub. Date: May 21, 2026

(54) LIQUID CONSUMPTION APPARATUS WITH MULTIPLE SENSORS FOR REMAINING LIQUID AMOUNT DETERMINATION AND NOTIFICATION CONTROL

(71) Applicant: BROTHER KOGYO KABUSHIKI KAISHA, Nagoya (JP)

(72) Inventor: Taichiro KIMOTO, Nagoya (JP)

(73) Assignee: BROTHER KOGYO KABUSHIKI KAISHA, Nagoya (JP)

(21) Appl. No.: 19/355,491

(22) Filed: Oct. 10, 2025

(30) Foreign Application Priority Data
Nov. 18, 2024 (JP) 2024-201015

(51) Int. Cl. B41J 2/175; B41J 29/46

(52) U.S. Cl. CPC B41J 2/17566; B41J 29/46

(57) ABSTRACT

A liquid consumption apparatus includes a liquid container having a reservoir configured to store liquid, and further includes an inlet that is open into the reservoir, an outlet that is open into the reservoir, a liquid consumption device configured to consume the liquid supplied through the outlet, a first sensor configured to detect the liquid stored in the reservoir, a second sensor configured to detect the liquid stored in the reservoir, a notification device, and a controller. The controller is configured to cause the notification device to provide a particular notification in response to determining that a difference between a first value based on a change in a signal output from the first sensor and a second value based on a change in a signal output from the second sensor is outside a particular range.

### REFERENCE TO RELATED APPLICATIONS

This application claims priority from Japanese Patent Application No. 2024-201015 filed on November 18, 2024. The entire content of the priority application is incorporated herein by reference.

### BACKGROUND ART

A printer has been known that includes a tank and a liquid cartridge configured to be removably connected to the tank. The tank includes a sensor disposed on a rear wall and configured to detect whether the ink surface level inside the tank has reached a first position. The first position is located in the vicinity of a liquid outlet disposed in a lower wall of the tank. When the ink surface level has fallen to the first position, the printer provides a notification based on detection by the sensor. This notification allows the user to recognize that the amount of ink remaining in the tank and/or in the cartridge is low.

### SUMMARY

In the known configuration, for instance, when the printer is placed on a surface inclined relative to a horizontal plane, the bottom surface of the tank is also inclined relative to the horizontal plane. In this state, the ink surface level inside the tank is inclined relative to the bottom surface of the tank. As a result, even if ink is stored in the tank with an ink surface level that would be above the first position under the assumption that the bottom surface is horizontal, the sensor may fail to detect the ink. Thus, if the printer continues to be used while placed on an inclined surface, there is a risk that the ink may not be properly consumed.

Aspects of the present disclosure are advantageous in providing one or more improved techniques for enabling a liquid consumption apparatus to provide a notification that takes into account a state in which the liquid consumption apparatus may be placed on a surface inclined with respect to a horizontal plane.

According to aspects of the present disclosure, a liquid consumption apparatus is provided, which includes a liquid container, an inlet, an outlet, a liquid consumption device, a first sensor, a second sensor, a notification device, and a controller. The liquid container has a reservoir configured to store liquid. The inlet is open into the reservoir. The outlet is open into the reservoir. The liquid consumption device is configured to consume the liquid supplied through the outlet. The first sensor is configured to detect the liquid stored in the reservoir. The second sensor is configured to detect the liquid stored in the reservoir. The controller is configured to cause the notification device to provide a particular notification in response to determining that a difference between a first value based on a change in a signal output from the first sensor and a second value based on a change in a signal output from the second sensor is outside a particular range.

### BRIEF DESCRIPTION OF DRAWINGS

FIG. 1 is an external perspective view of a multi-function peripheral (hereinafter referred to as the “MFP”).

FIG. 2 is a longitudinal sectional view schematically illustrating an internal configuration of a printer assembly.

FIG. 3 is a plan view schematically illustrating an internal configuration around a print engine in the printer assembly.

FIG. 4 is a schematic diagram illustrating a tank including ink sensors.

FIG. 5 is a block diagram illustrating an electrical configuration of a controller connected to other elements.

FIG. 6 is a flowchart illustrating processing by the controller.

FIG. 7 is a flowchart illustrating a procedure of a dot count process by the controller.

FIG. 8 is a flowchart illustrating a procedure of a remaining amount determination control finalization process by the controller.

FIG. 9A is a schematic diagram illustrating the tank and the ink sensors when the MFP is placed on a noticeably inclined surface.

FIG. 9B schematically illustrates the tank and the ink sensors when the MFP is placed on a more inclined surface than the inclined surface illustrated in FIG. 9A.

FIGS. 10A and 10B are flowcharts illustrating a procedure of a remaining amount determination process by the controller.

FIGS. 11A and 11B are flowcharts illustrating a procedure of a cartridge replacement process by the controller.

FIG. 12 is a schematic diagram illustrating a tank including ink sensors.

FIG. 13A is a schematic diagram illustrating the tank and the ink sensors when the MFP is placed on an inclined surface on which a right end of the tank is lower than a left end thereof.

FIG. 13B is a schematic diagram illustrating the tank and the ink sensors when the MFP is placed on an inclined surface on which the left end of the tank is lower than the right end thereof.

FIG. 14 is a cross-sectional side view illustrating a tank and a bottle.

### DESCRIPTION

It is noted that various connections are described between elements in the following description. These connections, unless specified otherwise, may be either direct or indirect, and this specification is not intended to be limiting in that respect. Aspects of the present disclosure may be implemented using circuits (such as application-specific integrated circuits) or computer software stored on computer-readable media, including but not limited to RAMs, ROMs, flash memories, EEPROMs, CD media, DVD media, temporary storage, hard disk drives, floppy drives, permanent storage, and the like.

As used herein, the term “processor” encompasses a single processor or a group of multiple processors, which may include a single-core processor, a multi-core processor, multiple processors within a single device, or multiple processors in wired or wireless communication with each other. Such processors may be locally or remotely distributed and may operate collaboratively or in a distributed fashion across a network of devices, the Internet, or the cloud to collectively perform the tasks attributed to the “processor” described herein. Similarly, the term “non-transitory computer-readable storage medium” encompasses a single storage medium or a group of multiple storage media, which may be locally or remotely distributed and may collectively store and provide access to instructions, data, or other information in a coordinated or distributed manner.

In the present disclosure, an inclusive OR — meaning that it includes either A, B, or both — may be expressed as “A and/or B,” “at least one of A or B,” or “at least one selected from the group consisting of A and B.” Additionally, the expression “one of A or B,” as used herein, refers to a case where A or B is selected exclusively, but not both. The same interpretation applies in cases where three or more selectable elements are considered.

### Illustrative Embodiment

Hereinafter, an illustrative embodiment according to aspects of the present disclosure will be described. It is noted that the illustrative embodiment to be described below is merely an example of the present disclosure, and modifications may be made to the illustrative embodiment as appropriate without departing from the spirit and scope of the technical concepts underlying the present disclosure.

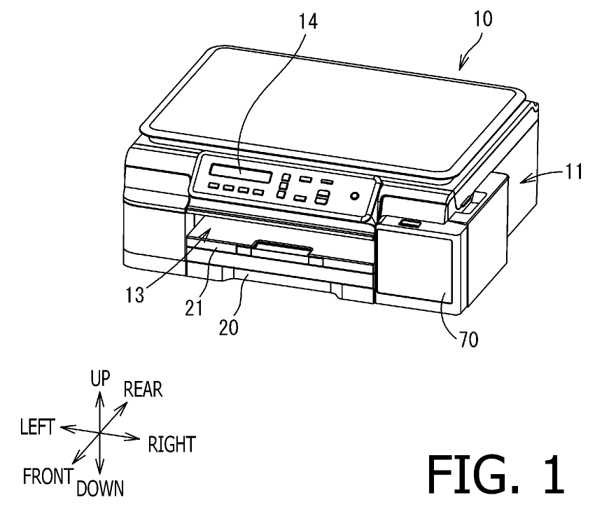

As illustrated in FIG. 1, vertical directions (i.e., an upward direction and a downward direction) are defined based on a posture in which a multi-function peripheral (hereinafter referred to as the “MFP”) 10 and a tank 103 installed in the MFP 10 are placed on a horizontal surface in a usable manner. This posture may be referred to as the “usage posture.” Based on the usage posture, front-rear directions (i.e., a frontward direction and a rearward direction) are defined in such a manner that a surface of the MFP 10 having an opening 13 is designated as a front surface. In addition, left-right directions (i.e., a leftward direction and a rightward direction) are defined based on the left and right as viewed from the front of the MFP 10. The vertical direction, the front-rear direction, and the left-right direction are mutually orthogonal. Hereinafter, a representative one of the vertical directions may be referred to in the singular as “the vertical direction.” The same applies to the front-rear directions and the left-right directions.

### Overall Configuration of Multi-Function Peripheral

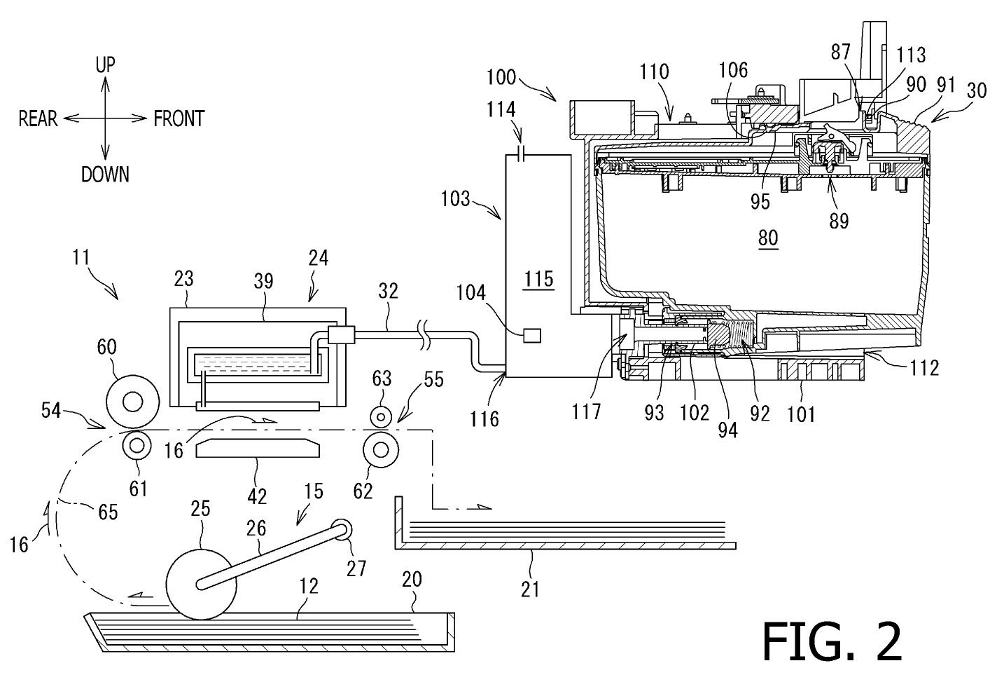

As illustrated in FIG. 1, an outer shape of the MFP 10 is substantially a rectangular parallelepiped. The MFP 10 includes a printer assembly 11. As illustrated in FIG. 2, the printer assembly 11 is configured to record an image on a sheet 12 by an inkjet recording method. The printer assembly 11 includes a sheet feeder 15, a feed tray 20, a discharge tray 21, a conveyance roller assembly 54, a print engine 24, a discharge roller assembly 55, a platen 42, and a refill assembly 100.

The MFP 10 has various functions such as a facsimile function and a printing function. The refill assembly 100 is disposed to the rear of a cover 70. As illustrated in FIG. 1, the cover 70 is provided on the front surface of the MFP 10 in an openable and closable manner. When the cover 70 is opened, the refill assembly 100 is exposed to the outside and becomes accessible. The MFP 10 may be an example of a “liquid consumption apparatus” according to aspects of the present disclosure.

### Display

As illustrated in FIG. 1, the MFP 10 further includes a display 14. The display 14 is disposed on a front wall of the MFP 10. The display 14 is configured to display characters and graphics. The characters and graphics displayed on the display 14 include messages presented to a user. These messages are predetermined. Examples of the predetermined messages include, but are not limited to, information indicating that an amount of ink stored in a second reservoir 115 is low, and information indicating that the posture of the MFP 10 is inclined and suggesting that the MFP 10 be placed on the horizontal surface.

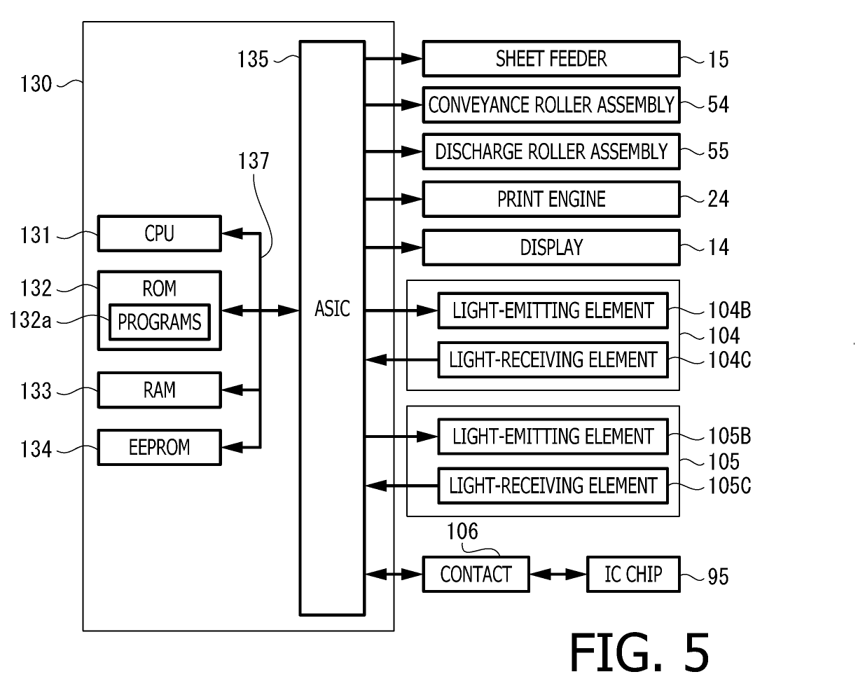

As illustrated in FIG. 5, the display 14 is connected to a controller 130. The display output of the display 14 is controlled by the controller 130.

### Feed Tray and Discharge Tray

As illustrated in FIG. 1, the opening 13 is formed in the front surface of the MFP 10 and is located at a middle portion in the left-right direction. The feed tray 20 is movable in the front-rear direction through the opening 13 by user operation.

As illustrated in FIG. 2, the feed tray 20 is configured to support a plurality of sheets 12 stacked thereon. The discharge tray 21 is disposed above the feed tray 20. The discharge tray 21 is movable in the front-rear direction together with the feed tray 20. The discharge tray 21 is configured to support the sheets 12 discharged by the discharge roller assembly 55.

### Sheet Feeder

As illustrated in FIG. 2, the sheet feeder 15 is configured to feed the sheets 12 supported by the feed tray 20 into a conveyance path 65. The sheet feeder 15 includes a pickup roller 25, a feed arm 26, and a shaft 27. The pickup roller 25 is rotatably supported at a distal end portion of the feed arm 26.

The pickup roller 25 is configured to be driven by a driving force from a conveyance motor (not shown) and to rotate in a direction for conveying the sheets 12 in a conveyance direction 16. The feed arm 26 is rotatably supported by the shaft 27. The shaft 27 is supported by a frame of the printer assembly 11. The feed arm 26 is urged to rotate toward the feed tray 20 by its own weight or by an elastic force, for instance, from a spring.

### Conveyance Path

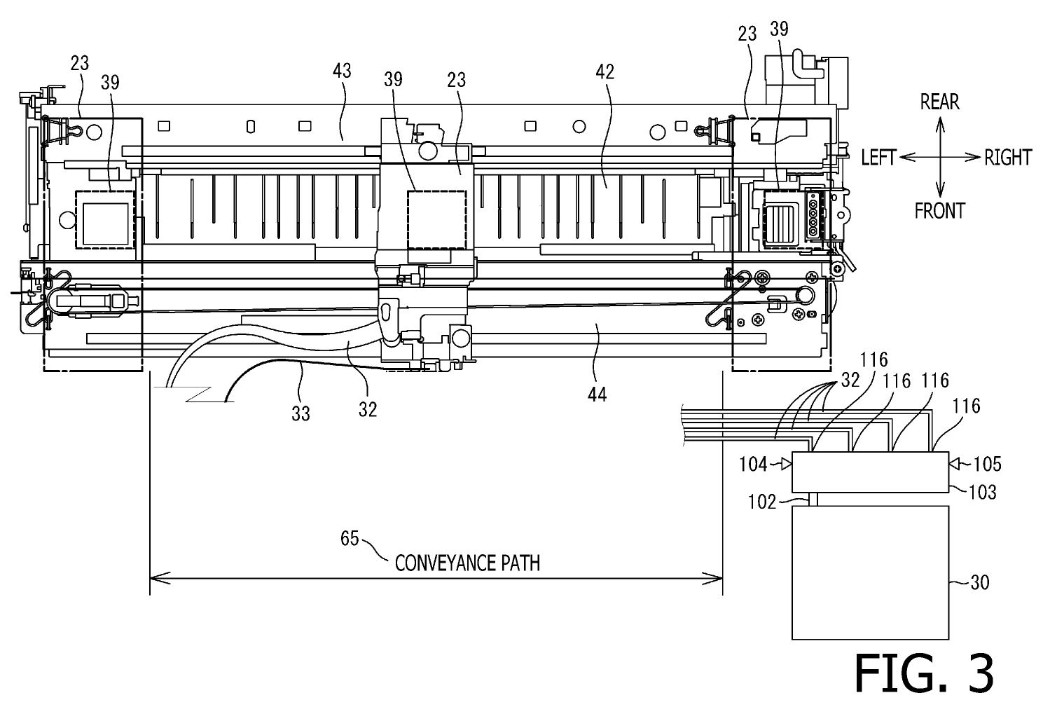

The conveyance path 65 refers to, for instance, a space defined within the printer assembly 11 by an inner guide member and an outer guide member facing each other across a particular distance. As illustrated in FIG. 2, the conveyance path 65 extends upward from a rear end of the feed tray 20, turns forward in a U-shape, passes through a space between the print engine 24 and the platen 42, and reaches the discharge tray 21. As illustrated in FIGS. 2 and 3, between the conveyance roller assembly 54 and the discharge roller assembly 55, the conveyance path 65 extends along the front-rear direction (more specifically, in the frontward direction) and is located substantially at a central portion of the MFP 10 in the left-right direction. The conveyance direction 16 is indicated by arrows in FIG. 2.

### Conveyance Roller Assembly

As illustrated in FIG. 2, the conveyance roller assembly 54 is disposed upstream of the print engine 24 in the conveyance direction 16. The conveyance roller assembly 54 includes a conveyance roller 60 and a pinch roller 61. The conveyance roller 60 and the pinch roller 61 face each other in the vertical direction. The conveyance roller 60 is configured to be driven to rotate in response to receiving a driving force from the conveyance motor (not shown). The pinch roller 61 is configured to rotate in conjunction with the rotation of the conveyance roller 60. When the conveyance roller 60 rotates, the sheet 12 is conveyed in the conveyance direction 16 while being nipped between the conveyance roller 60 and the pinch roller 61.

### Discharge Roller Assembly

As illustrated in FIG. 2, the discharge roller assembly 55 is disposed downstream of the print engine 24 in the conveyance direction 16. The discharge roller assembly 55 includes a discharge roller 62 and a spur 63. The discharge roller 62 and the spur 63 face each other in the vertical direction. The discharge roller 62 is configured to be driven to rotate in response to receiving a driving force from the conveyance motor. The spur 63 is configured to rotate in conjunction with the rotation of the discharge roller 62. When the discharge roller 62 rotates, the sheet 12 is conveyed in the conveyance direction 16 while being nipped between the discharge roller 62 and the spur 63.

### Print Engine

As illustrated in FIG. 2, the print engine 24 is disposed between the conveyance roller assembly 54 and the discharge roller assembly 55 in the conveyance direction 16. The print engine 24 faces the platen 42 in the vertical direction across the conveyance path 65. The print engine 24 is positioned above the conveyance path 65 in the vertical direction. The print engine 24 includes a carriage 23 and a recording head 39.

As illustrated in FIG. 3, the carriage 23 is supported by a guide rail 43 and a guide rail 44. The guide rails 43 and 44 are supported by a frame of the printer assembly 11. The guide rails 43 and 44 are spaced apart from each other in the front-rear direction. Each of the guide rails 43 and 44 has an elongated external shape extending in the left-right direction.

The carriage 23 is connected to a belt mechanism. The belt mechanism is provided on the guide rail 44. Since the belt mechanism has a known configuration, a detailed description thereof is omitted. The belt mechanism is configured to be driven to rotate in response to a driving force from a carriage motor. When the belt mechanism rotates, the carriage 23 moves along the left-right direction. A movable range of the carriage 23 is indicated by dot-dash lines in FIG. 3. The carriage 23 is movable to positions located outside the left and right ends of the conveyance path 65 in the left-right direction.

As illustrated in FIG. 3, the refill assembly 100 and the recording head 39 are connected to each other via ink tubes 32. As illustrated in FIG. 5, the controller 130 and the recording head 39 are electrically connected to each other. As illustrated in FIG. 3, the recording head 39 is connected to the controller 130 via a flexible flat cable 33.

As illustrated in FIG. 3, four ink tubes 32 connect the recording head 39 to the tank 103. Through the four ink tubes 32, ink stored in the tank 103 is supplied to the recording head 39. It is noted that the number of ink tubes 32 is not limited to four and may be any number equal to or greater than one. A plurality of ink tubes may extend from the tank 103 and be connected to a single ink tube, which may be connected to the recording head 39.

As illustrated in FIG. 2, the carriage 23 has the recording head 39 mounted thereon. Although not shown in any drawings, a plurality of nozzles are disposed in a lower surface of the recording head 39. The nozzles are arranged in four rows along the front-rear direction. The four nozzle rows are spaced apart from each other in the left-right direction. The four nozzle rows correspond to the four ink tubes 32, respectively. Each ink tube 32 is configured to supply ink to the corresponding nozzle row.

Although not shown in any drawings, the recording head 39 includes a plurality of piezoelectric elements corresponding to the plurality of nozzles. During image recording, a head control board selectively applies drive voltages to the piezoelectric elements based on recording data. In response to the deformation of selected piezoelectric elements, ink is selectively ejected as minute droplets from the corresponding nozzles. As the carriage 23 moves, the recording head 39 ejects the ink droplets toward the sheet 12, thereby recording an image on the sheet 12.

### Platen

As illustrated in FIGS. 2 and 3, the platen 42 is disposed between the conveyance roller assembly 54 and the discharge roller assembly 55 in the conveyance direction 16. The platen 42 faces the print engine 24 in the vertical direction. The platen 42 is configured to support the sheet 12 from below.

### Refill Assembly

As illustrated in FIG. 2, the MFP 10 includes the refill assembly 100. The refill assembly 100 is configured to supply ink to the recording head 39. The refill assembly 100 includes a cartridge mounting section 110 and the tank 103. The cartridge mounting section 110 is configured to support an ink cartridge 30 mounted therein.

FIG. 2 illustrates a state in which the ink cartridge 30 is mounted in the cartridge mounting section 110. The state of the ink cartridge 30 in FIG. 2 may be referred to as the “mounted state.” A posture of the ink cartridge 30 in the mounted state corresponds to a usage posture. A positional relationship between the print engine 24 and the refill assembly 100 in FIG. 2 differs from the actual positional relationship. In FIG. 2, a first reservoir 80 of the ink cartridge 30 is located above the print engine 24. However, in actuality, the first reservoir 80 is located below the print engine 24.

### Cartridge Mounting Section

As illustrated in FIG. 2, the cartridge mounting section 110 includes a cartridge case 101, an ink needle 102, and a contact 106. The cartridge case 101 is box-shaped and has a rearward opening 112. The opening 112 is configured to be exposed at the front surface of the MFP 10. The front surface of the MFP 10 is a surface that the user faces when operating the MFP 10.

When the cover 70 of the MFP 10 shown in FIG. 1 is opened, the opening 112 of the cartridge case 101 is exposed to the outside. The ink cartridge 30 is configured to be inserted into the cartridge case 101 through the opening 112 and to be removed from the cartridge case 101 through the opening 112.

As illustrated in FIG. 2, the ink needle 102 is a hollow tube. The ink needle 102 is disposed at a lower portion of an end surface of the cartridge case 101. The end surface defines a rear end of an internal space of the cartridge case 101. The ink needle 102 protrudes forward from the end surface. A front end of the ink needle 102 is open forward. A rear end of the ink needle 102 is open into the second reservoir 115 of the tank 103.

A lock shaft 113 is disposed at a position near the opening 112 and near an upper end within the internal space of the cartridge case 101. The lock shaft 113 is a rod extending in the left-right direction. The ink cartridge 30 has a lock surface 90 configured to abut against the lock shaft 113 from the front. This configuration allows the ink cartridge 30 to be held within the cartridge case 101.

As illustrated in FIG. 2, a single tank 103 is disposed behind (i.e., to the rear of) the cartridge case 101. The tank 103 has substantially the same size as the cartridge case 101 in the left-right direction. The tank 103 is box-shaped and has the second reservoir 115 therein. The second reservoir 115 is configured to store ink. An atmospheric communication port 114 is disposed at an upper portion of the tank 103. Through the atmospheric communication port 114, the second reservoir 115 is in communication with the outside of the tank 103. Accordingly, the second reservoir 115 is open to the atmosphere. The second reservoir 115 is in communication with an internal space of the ink needle 102 at its front end portion.

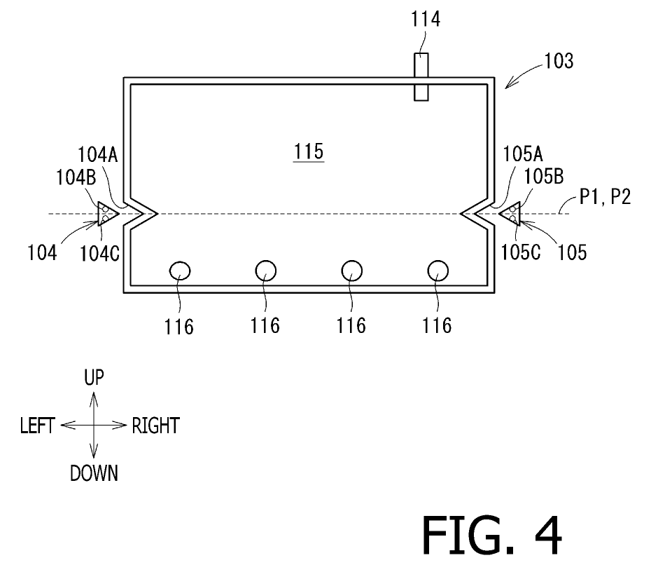

As illustrated in FIG. 4, four outlets 116 are disposed in a rear surface of the second reservoir 115. The four outlets 116 are arranged side by side at intervals in the left-right direction. Each of the four outlets 116 is connected to a corresponding one of the ink tubes 32. Ink stored in the second reservoir 115 is supplied to the recording head 39 through the four ink tubes 32 via the four outlets 116. It is noted that only one outlet 116 and one ink tube 32 are shown in FIG. 2.

As illustrated in FIG. 4, the tank 103 includes an ink sensor 104 and an ink sensor 105. The ink sensors 104 and 105 are spaced apart from each other in the left-right direction. The ink sensors 104 and 105 are disposed outside the tank 103 at substantially the same vertical position (i.e., the same height) as the ink needle 102.

The ink sensor 104 is disposed to the left of the tank 103. The ink sensor 104 includes a light-emitting element 104B configured to emit light toward the tank 103, and a light-receiving element 104C configured to receive light from the tank 103. An outer wall of the tank 103 at a position facing the ink sensor 104 is formed of a light-transmissive prism 104A. The prism 104A is configured to reflect light from the light-emitting element 104B when ink in the second reservoir 115 is in contact with the prism 104A, and to transmit the light when the ink is not in contact therewith. The ink sensor 104 is configured to output a signal according to the intensity of light received by the light-receiving element 104C. Based on the signal output from the ink sensor 104, the controller 130 determines whether ink is present at the height at which the ink sensor 104 is located in the second reservoir 115.

The ink sensor 105 is disposed to the right of the tank 103. The ink sensor 105 includes a light-emitting element 105B configured to emit light toward the tank 103, and a light-receiving element 105C configured to receive light from the tank 103. An outer wall of the tank 103 at a position facing the ink sensor 105 is formed of a light-transmissive prism 105A. The prism 105A is configured to reflect light from the light-emitting element 105B when ink in the second reservoir 115 is in contact with the prism 105A, and to transmit the light when the ink is not in contact therewith. The ink sensor 105 is configured to output a signal according to the intensity of light received by the light-receiving element 105C. Based on the signal output from the ink sensor 105, the controller 130 determines whether ink is present at the height at which the ink sensor 105 is located in the second reservoir 115.

As illustrated in FIG. 2, the contact 106 is disposed near the upper end within the internal space of the cartridge case 101 and behind (i.e., to the rear of) the lock shaft 113. The contact 106 is electrically connected to an IC chip 95 of the ink cartridge 30. The controller 130 is configured to access information stored in the IC chip 95 of the ink cartridge 30 through the contact 106.

### Ink Cartridge

The ink cartridge 30 is a container configured to store ink. The ink cartridge 30 includes the first reservoir 80, a protrusion 87, an atmospheric communication port 89, the lock surface 90, an operation portion 91, an ink supply portion 92, and the IC chip 95. As illustrated in FIG. 2, an internal space of the ink cartridge 30 defines the first reservoir 80. The first reservoir 80 is configured to store ink.

The ink cartridge 30 has the protrusion 87 protruding upward from an upper wall thereof. The protrusion 87 has an internal space connected to the atmospheric communication port 89 of the first reservoir 80. The protrusion 87 has an upward opening. Through the opening and the internal space of the protrusion 87, the atmospheric communication port 89 is in communication with the outside of the ink cartridge 30. Accordingly, the first reservoir 80 is in communication with the atmosphere. In other words, the first reservoir 80 is open to the atmosphere.

A front-facing surface of the protrusion 87 serves as the lock surface 90. The lock surface 90 extends in the vertical direction. In a state in which the ink cartridge 30 is mounted in the cartridge mounting section 110, the lock surface 90 faces forward and abuts against the lock shaft 113.

The operation portion 91 is disposed in front of the lock surface 90. The operation portion 91 is configured to be operated by the user to remove the ink cartridge 30 from the cartridge mounting section 110.

The ink supply portion 92 is disposed below the first reservoir 80. The ink supply portion 92 includes a supply port 93 that is open rearward. The supply port 93 is in communication with the first reservoir 80. The supply port 93 is configured to be opened and closed by a valve 94. The supply port 93 is further configured in such a manner that the ink needle 102 is insertable thereinto. The internal space of the ink needle 102 inserted into the supply port 93 is in communication with the first reservoir 80.

Ink stored in the first reservoir 80 flows into the second reservoir 115 of the tank 103 through the opening 117 of the ink needle 102 inserted into the supply port 93. The first reservoir 80 and the second reservoir 115 are each in communication with the atmosphere (i.e., each of the first reservoir 80 and the second reservoir 115 is open to the atmosphere). Accordingly, due to a difference in liquid surface level between the first reservoir 80 and the second reservoir 115, the ink flows from the first reservoir 80 to the second reservoir 115.

The IC chip 95 is disposed behind (i.e., to the rear of) the lock surface 90. The IC chip 95 is exposed upward on an upper wall of the ink cartridge 30. The IC chip 95 stores information such as identification information of the ink cartridge 30.

### Controller

As illustrated in FIG. 5, the controller 130 includes a CPU 131, a ROM 132, a RAM 133, an EEPROM 134, and an ASIC 135. The CPU 131, the ROM 132, the RAM 133, the EEPROM 134, and the ASIC 135 are interconnected via an internal bus 137. The ROM 132 is configured to store programs 132a that are executable by the CPU 131 to control various operations. The RAM 133 is configured to serve as a memory area for temporarily storing data or signals used by the CPU 131 when executing the programs 132a, and/or as a working area for data processing. The EEPROM 134 is configured to store settings and flags that are to be retained even after the MFP 10 is powered off.

Specifically, the EEPROM 134 stores, for instance, a threshold T1, a threshold T2, an empty threshold E1, an empty threshold E2, an empty threshold E3, an empty threshold E4, a total soft count value AC, a sensor dot count value SC1, a sensor dot count value SC2, a plurality of display contents, a flag indicating whether ink remains in the ink cartridge 30, and a flag indicating whether the ink cartridge 30 is in a usable state.

The total soft count value AC is calculated based on, for instance, ink droplets ejected from the nozzles of the recording head 39 and indicates an estimated amount of ink consumed by the recording head 39. In other words, the total soft count value AC has a negative correlation with the amount of ink stored in the second reservoir 115, thereby representing how low the amount of ink stored in the second reservoir 115 of the tank 103 is. That is, the larger the total soft count value AC is, the lower the amount of ink stored in the second reservoir 115 is.

The sensor dot count value SC1 is calculated based on, for instance, ink droplets ejected from the nozzles of the recording head 39 after a signal output from the ink sensor 104 changes from a low level to a high level. The sensor dot count value SC2 is calculated based on, for instance, ink droplets ejected from the nozzles of the recording head 39 after a signal output from the ink sensor 105 changes from a low level to a high level.

Examples of the plurality of display contents may include, but are not limited to, messages presented to the user. The messages may be predefined and stored in the EEPROM 134. The messages may include a message indicating that a remaining amount of ink stored in the second reservoir 115 is low. The messages may further include a message indicating that the posture of the MFP 10 is inclined and suggesting that the MFP 10 be placed on a horizontal surface. The messages may further include a message indicating that the posture of the MFP 10 may be inclined or that a sensor failure may have occurred. The messages may further include “Empty” and “Near Empty.”

The flag indicating whether ink remains in the ink cartridge 30 is represented, for instance, by a binary value of “0” or “1.” When the flag is “1,” the controller 130 determines that no ink remains in the ink cartridge 30. When the flag is “0,” the controller 130 determines that ink remains in the ink cartridge 30.

The flag indicating whether the ink cartridge 30 is in a usable state is represented, for instance, by a binary value of “0” or “1.” When the flag is “1,” the controller 130 determines that the ink cartridge 30 is in a usable state. When the flag is “0,” the controller 130 determines that the ink cartridge 30 is not in a usable state.

The ASIC 135 is electrically connected to the sheet feeder 15, the conveyance roller assembly 54, the discharge roller assembly 55, the print engine 24, the display 14, the ink sensor 104, and the ink sensor 105. The controller 130 is configured to cause the sheet feeder 15, the conveyance roller assembly 54, and the discharge roller assembly 55 to convey the sheet 12. The controller 130 is further configured to cause the recording head 39 of the print engine 24 to eject ink.

The ink sensor 104 is configured to detect whether a liquid surface level of ink in the second reservoir 115 has reached a detection position P1. The ink sensor 104 includes the light-emitting element 104B and the light-receiving element 104C.

As illustrated in FIG. 4, the prism 104A is disposed below a vertical center of the outer wall of the tank 103. The prism 104A forms part of the outer wall of the tank 103. The prism 104A is formed of glass having a reflectance that varies depending on whether it is in contact with ink. The detection position P1 corresponds to the position of the prism 104A.

The light-emitting element 104B and the light-receiving element 104C are disposed to the left of the prism 104A and face the prism 104A in the left-right direction. The light-emitting element 104B is configured to emit light toward the prism 104A. The light-receiving element 104C is configured to receive light emitted from the light-emitting element 104B and then reflected by the prism 104A. The light-receiving element 104C is configured to output, to the controller 130, a signal based on the intensity of the received light.

When the liquid surface level of ink stored in the second reservoir 115 is higher than the detection position P1, the ink comes into contact with the prism 104A in the optical path of light emitted from the light-emitting element 104B. In this case, the light emitted from the light-emitting element 104B toward the prism 104A passes through the prism 104A and enters the second reservoir 115, and thus does not reach the light-receiving element 104C. Accordingly, the light-receiving element 104C outputs a low-level signal to the controller 130.

When the liquid surface level of ink stored in the second reservoir 115 is equal to or lower than the detection position P1, the ink does not come into contact with the prism 104A in the optical path of light emitted from the light-emitting element 104B. In this case, the light emitted from the light-emitting element 104B toward the prism 104A is reflected by the prism 104A and reaches the light-receiving element 104C. Accordingly, the light-receiving element 104C outputs a high-level signal to the controller 130.

It is noted that the light-receiving element 104C may output a high-level signal when the liquid surface level of ink stored in the second reservoir 115 is equal to or higher than the detection position P1. Conversely, the light-receiving element 104C may output a low-level signal when the liquid surface level is lower than the detection position P1.

The ink sensor 105 is configured to detect whether the liquid surface level of ink in the second reservoir 115 has reached a detection position P2. The ink sensor 105 includes the light-emitting element 105B and the light-receiving element 105C.

As illustrated in FIG. 4, the prism 105A is disposed below the vertical center of the outer wall of the tank 103. The vertical position of the prism 105A is substantially the same as that of the prism 104A. The prism 105A forms part of the outer wall of the tank 103. The prism 105A is formed of glass having a reflectance that varies depending on whether it is in contact with ink. The detection position P2 corresponds to the position of the prism 105A.

The light-emitting element 105B and the light-receiving element 105C are disposed to the right of the prism 104A and face the prism 105A in the left-right direction. The light-emitting element 105B is configured to emit light toward the prism 105A. The light-receiving element 105C is configured to receive light emitted from the light-emitting element 105B and then reflected by the prism 105A. The light-receiving element 105C is configured to output, to the controller 130, a signal based on the intensity of the received light.

When the liquid surface level of ink stored in the second reservoir 115 is higher than the detection position P2, the ink comes into contact with the prism 105A in the optical path of light emitted from the light-emitting element 105B. In this case, the light emitted from the light-emitting element 105B toward the prism 105A passes through the prism 105A and enters the second reservoir 115, and thus does not reach the light-receiving element 105C. Accordingly, the light-receiving element 105C outputs a low-level signal to the controller 130.

When the liquid surface level of ink stored in the second reservoir 115 is equal to or lower than the detection position P2, the ink does not come into contact with the prism 105A in the optical path of light emitted from the light-emitting element 105B. In this case, the light emitted from the light-emitting element 105B toward the prism 105A is reflected by the prism 105A and reaches the light-receiving element 105C. Accordingly, the light-receiving element 105C outputs a high-level signal to the controller 130.

It is noted that the light-receiving element 105C may output a high-level signal when the liquid surface level of ink stored in the second reservoir 115 is equal to or higher than the detection position P2. Conversely, the light-receiving element 105C may output a low-level signal when the liquid surface level of ink stored in the second reservoir 115 is lower than the detection position P2.

The controller 130 may be configured to perform various types of processing by the CPU 131 alone, the ASIC 135 alone, or in cooperation with the CPU 131 and the ASIC 135. Further, the controller 130 may perform the processing using either a single CPU 131 or multiple CPUs 131 that share the processing. Likewise, the controller 130 may perform the processing using either a single ASIC 135 or multiple ASICs 135 that share the processing. If the controller 130 is configured to perform various types of processing by the CPU 131, the CPU 131 may be configured to execute programs 132a stored in the ROM 132, thereby performing the processing in accordance with the flowcharts to be described below. In this case, the CPU 131 may be an example of a “processor” according to aspects of the present disclosure, and the ROM 132 may be an example of a “non-transitory computer-readable storage medium” according to aspects of the present disclosure.

### Operations of MFP

Operations of the MFP 10 will be described. A typical image recording process is described below. The controller 130 receives print data from an information processing device communicably connected to the MFP 10. In response to receiving the print data, the controller 130 drives the sheet feeder 15, the conveyance roller assembly 54, and the discharge roller assembly 55. As a result, a sheet 12 placed on the feed tray 20 is conveyed along the conveyance path 65 and reaches a position below the recording head 39 (i.e., a position at which image recording is performed using the recording head 39). The controller 130 causes the recording head 39 to eject ink from the plurality of nozzles toward the sheet 12, thereby recording an image on the sheet 12. The controller 130 drives the discharge roller assembly 55 to discharge the sheet 12 onto the discharge tray 21.

Ink stored in the second reservoir 115 is consumed as ink is ejected from the recording head 39. Through the atmospheric communication port 114, ambient air flows into the second reservoir 115. As a result, the liquid surface level of the ink in the second reservoir 115 decreases. It is noted that the ink in the second reservoir 115 may also be consumed when ink is forcibly ejected from the plurality of nozzles of the recording head 39, for instance, during a purge process. An explanation of a detailed configuration for executing the purge process is omitted. In addition, the ink in the second reservoir 115 may be consumed when ink droplets are continuously ejected from the plurality of nozzles of the recording head 39, for instance, during a flushing process. The image recording process, the purge process, and the flushing process may be collectively referred to as “ink consumption processes.”

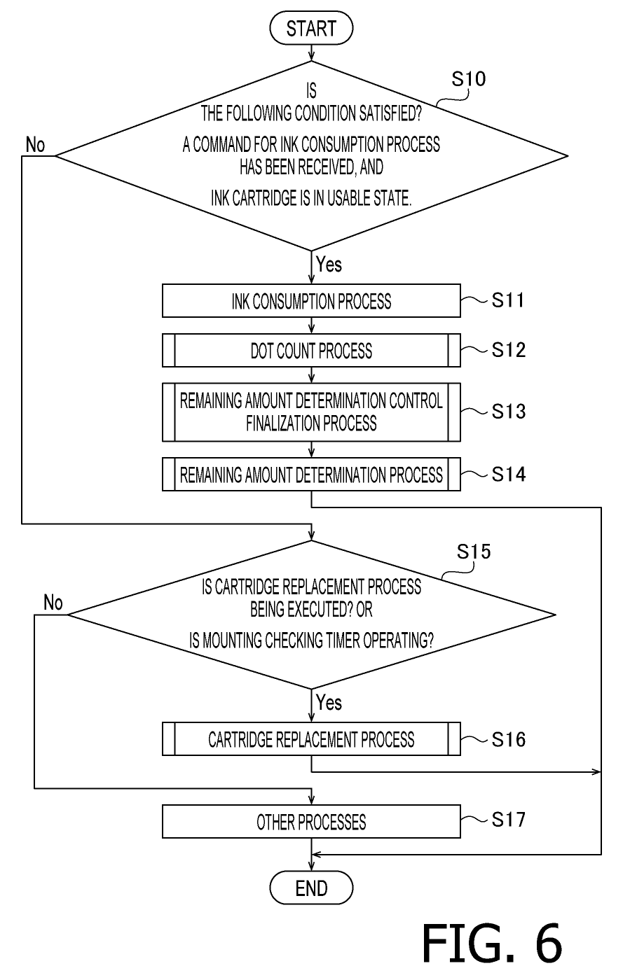

As illustrated in FIG. 6, the controller 130 determines whether a command for an ink consumption process has been received and the ink cartridge 30 is in a usable state (S10). Examples of cases in which the controller 130 receives a command for an ink consumption process may include, but are not limited to, a case in which the controller 130 receives print data from an information processing device. In S10, for instance, the controller 130 may determine whether the ink cartridge 30 is in a usable state based on whether the flag stored in the EEPROM 134, indicating whether ink remains in the ink cartridge 30, is set to “0” (i.e., ink remains) or “1” (i.e., no ink remains). When the condition in S10 is satisfied (S10: Yes)—i.e., in response to determining that a command for an ink consumption process has been received and ink remains in the ink cartridge 30, the controller 130 proceeds to S11 to perform an ink consumption process such as the image recording process described above.

After completing the ink consumption process (S11), the controller 130 proceeds to S12 to perform a dot count process.

### Dot Count Process

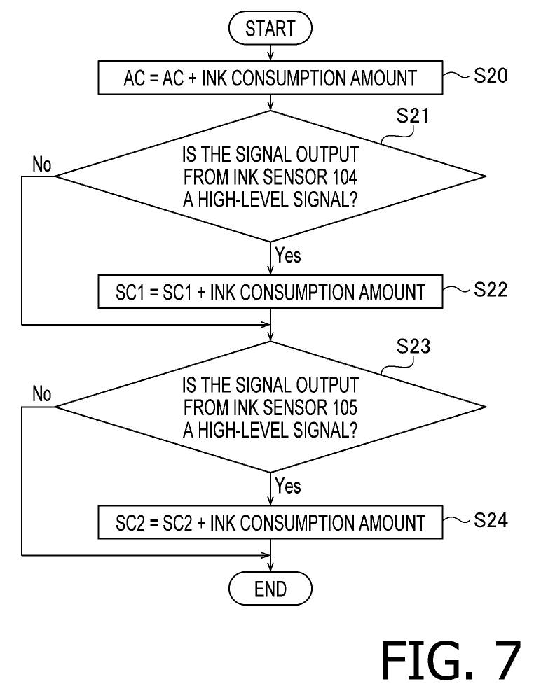

FIG. 7 is a flowchart illustrating a procedure of the dot count process. As illustrated in FIG. 7, the controller 130 adds an ink consumption amount to the total soft count value AC stored in the EEPROM 134, thereby updating the total soft count value AC (S20). The ink consumption amount corresponds to the total amount of ink droplets ejected from the plurality of nozzles of the recording head 39 during the ink consumption process. For instance, if the ink consumption process is executed for the first time after replacement of the ink cartridge 30, the total soft count value AC stored in the EEPROM 134 is “0.” The controller 130 adds an estimated ink consumption amount from the immediately preceding ink consumption process to the total soft count value AC. The estimated ink consumption amount refers to an amount of ink that is estimated to have been consumed during the immediately preceding ink consumption process.

The controller 130 determines whether the signal output from the ink sensor 104 is a high-level signal (S21). The ink sensor 104 outputs a low-level signal when the liquid surface level in the second reservoir 115 is above the detection position P1. The ink sensor 104 outputs a high-level signal when the liquid surface level in the second reservoir 115 falls below the detection position P1. Accordingly, as the liquid surface level in the second reservoir 115 decreases, the signal output from the ink sensor 104 changes from a low-level signal to a high-level signal. In response to determining that the signal output from the ink sensor 104 is not a high-level signal (S21: No), the controller 130 proceeds to S23.

In response to determining that the signal output from the ink sensor 104 is a high-level signal (S21: Yes), the controller 130 adds the estimated ink consumption amount from the immediately preceding ink consumption process to the sensor dot count value SC1, thereby updating the sensor dot count value SC1 (S22). The initial value of the sensor dot count value SC1 is “0.”

The controller 130 determines whether the signal output from the ink sensor 105 is a high-level signal (S23). The ink sensor 105 outputs a low-level signal when the liquid surface level in the second reservoir 115 is above the detection position P2. The ink sensor 105 outputs a high-level signal when the liquid surface level in the second reservoir 115 falls below the detection position P2. Accordingly, as the liquid surface level in the second reservoir 115 decreases, the signal output from the ink sensor 105 changes from a low-level signal to a high-level signal. In response to determining that the signal output from the ink sensor 105 is not a high-level signal (S23: No), the controller 130 ends the dot count process.

In response to determining that the signal output from the ink sensor 105 is a high-level signal (S23: Yes), the controller 130 adds the estimated ink consumption amount from the immediately preceding ink consumption process to the dot count value SC2, thereby updating the dot count value SC2 (S24). The initial value of the dot count value SC2 is “0.” After executing S24, the controller 130 ends the dot count process.

As illustrated in FIG. 6, after completing the dot count process (S12), the controller 130 proceeds to S13 to perform a remaining amount determination control finalization process.

### Remaining Amount Determination Control Finalization Process

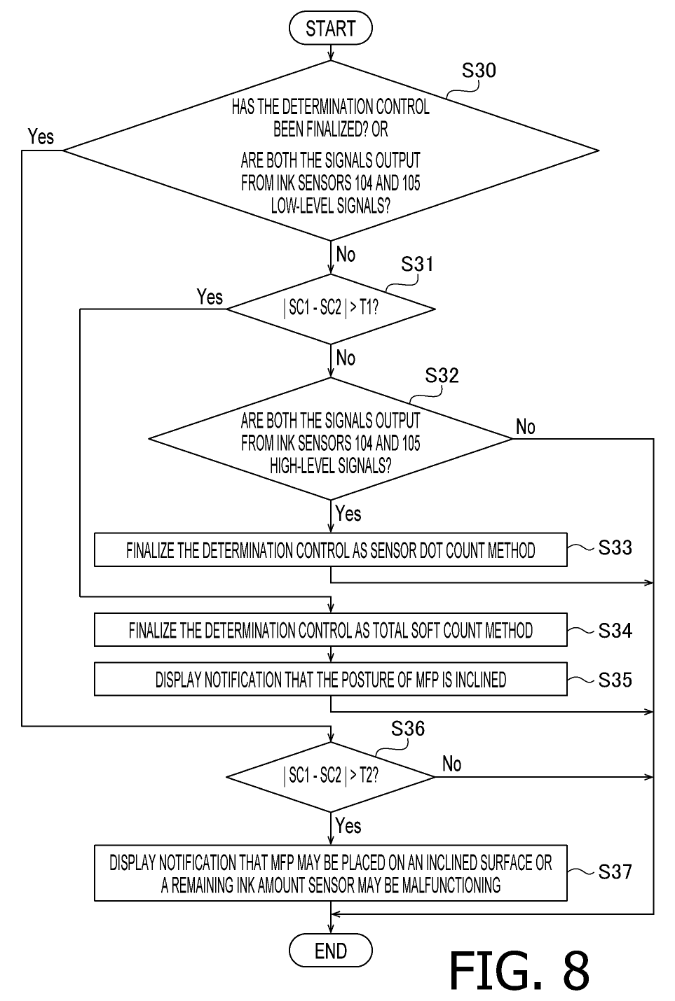

FIG. 8 is a flowchart illustrating a procedure of the remaining amount determination control finalization process. As illustrated in FIG. 8, the controller 130 determines whether at least one of two conditions—i.e., a condition in which the determination control has been finalized or a condition in which the signal output from the ink sensor 104 is a low-level signal and the signal output from the ink sensor 105 is also a low-level signal—is satisfied (S30). In response to determining that the determination control has been finalized (S30: Yes), the controller 130 proceeds to S36. In response to determining that the signal output from the ink sensor 104 is a low-level signal and the signal output from the ink sensor 105 is also a low-level signal (S30: Yes), the controller 130 also proceeds to S36.

In response to determining that none of the above two conditions is satisfied—i.e., when the determination control has not been finalized and at least one of the signals output from the ink sensors 104 and 105 is a high-level signal (S30: No), the controller 130 proceeds to S31. In S31, the controller 130 determines whether a difference between the sensor dot count value SC1 and the sensor dot count value SC2 exceeds a threshold T1.

For instance, as illustrated in FIG. 4, suppose that the MFP 10 is placed on a horizontal surface. In FIG. 4, the detection position P1 of the ink sensor 104 and the detection position P2 of the ink sensor 105 are at substantially the same vertical position (i.e., the same height). Suppose, in another instance, that the MFP 10 is placed on a slightly inclined surface. In this case, the detection positions P1 and P2 are located at different heights in the vertical direction. However, the difference in height between the two positions is relatively small. In such cases, the difference between the sensor dot count values SC1 and SC2 is also relatively small and equal to or less than the threshold T1 (i.e., the difference therebetween does not exceed the threshold T1).

In addition, when the sensor dot count value SC1 is “0” or the sensor dot count value SC2 is “0,” the difference between the sensor dot count values SC1 and SC2 tends to be relatively small. When the signal output from the ink sensor 104 is a low-level signal, the sensor dot count value SC1 is “0.” When the signal output from the ink sensor 105 is a low-level signal, the sensor dot count value SC2 is “0.”

In response to determining that the difference between the sensor dot count values SC1 and SC2 is equal to or less than the threshold T1 (S31: No), the controller 130 determines whether the signal output from the ink sensor 104 is a high-level signal and the signal output from the ink sensor 105 is also a high-level signal (S32). If both the signal output from the ink sensor 104 and the signal output from the ink sensor 105 are high-level signals (S32: Yes), the liquid surface level in the second reservoir 115 is lower than both the detection position P1 and the detection position P2. In this case, the controller 130 finalizes the determination control as a sensor dot count method (S33).

The sensor dot count method refers to control for determining the remaining amount based on the sensor dot count values SC1 and SC2. In response to determining that the signal output from the ink sensor 104 is a low-level signal (S32: No), the controller 130 ends the remaining amount determination control finalization process. In response to determining that the signal output from the ink sensor 105 is a low-level signal (S32: No), the controller 130 also ends the remaining amount determination control finalization process. In these cases, the determination control is not finalized.

In response to determining that the difference between the sensor dot count values SC1 and SC2 exceeds the threshold T1 (S31: Yes), the controller 130 finalizes the determination control as a total soft count method (S34). The controller 130 also causes the display 14 to display information indicating that the remaining amount of ink in the second reservoir 115 is determined using the total soft count method.

The total soft count method refers to control for determining the remaining amount based on the total soft count value AC without using the sensor dot count values SC1 and SC2.

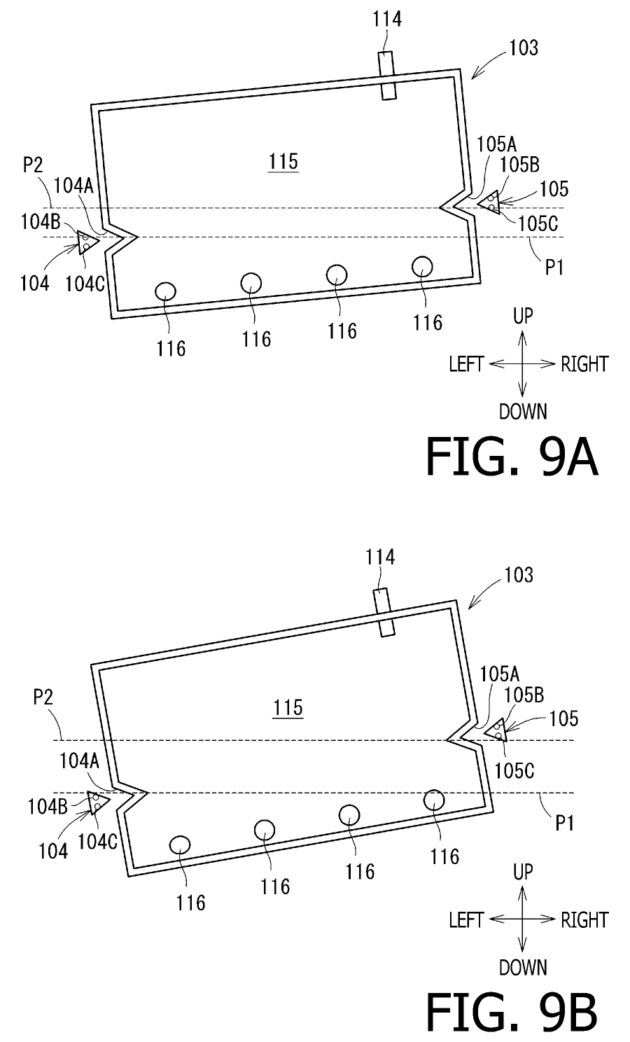

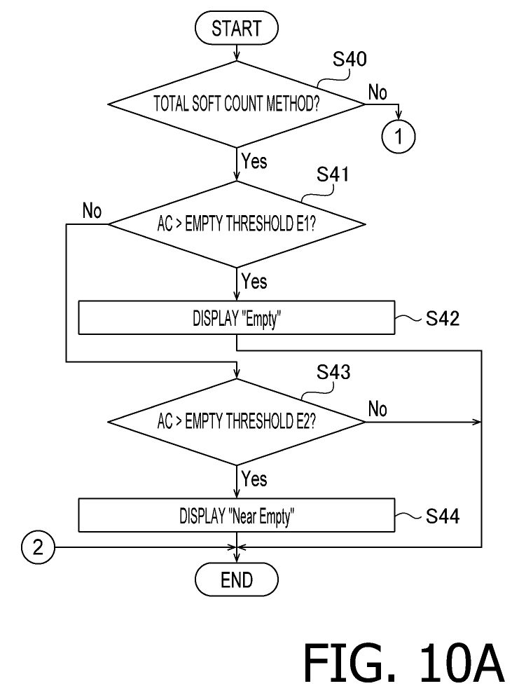

For instance, as illustrated in FIG. 9A, suppose that the MFP 10 is placed on a noticeably inclined surface. In FIG. 9A, the detection positions P1 and P2 of the ink sensors 104 and 105 are located at significantly different heights in the vertical direction. In this case, the difference between the sensor dot count values SC1 and SC2 becomes relatively large, and thus exceeds the threshold T1.

In S35, the controller 130 reads a message from the EEPROM 134 and causes the display 14 to display the message, which includes, for instance, “Since the posture of the MFP 10 is inclined, please place the MFP 10 on a horizontal surface.” This message allows the user to recognize that the MFP 10 is placed on a noticeably inclined surface.

In S36, the controller 130 determines whether the difference between the sensor dot count values SC1 and SC2 exceeds the threshold T2. In response to determining that the difference between the sensor dot count values SC1 and SC2 is equal to or less than the threshold T2 (S36: No), the controller 130 ends the remaining amount determination control finalization process. In this case, if the determination control has not yet been finalized, the determination control remains unfinalized. The threshold T2 is greater than the threshold T1.

In response to determining that the difference between the sensor dot count values SC1 and SC2 exceeds the threshold T2 (S36: Yes), the controller 130 proceeds to S37 to read a message from the EEPROM 134 and causes the display 14 to display the message, which includes, for instance, “Since the posture of the MFP 10 is inclined, please place the MFP 10 on a horizontal surface. If the MFP 10 is already placed on a horizontal surface, a remaining ink amount sensor may be malfunctioning.” This message allows the user to recognize that the MFP 10 may be placed on a noticeably inclined surface or that a remaining ink amount sensor may be malfunctioning.

For instance, as illustrated in FIG. 9B, suppose that the MFP 10 is placed on a more inclined surface than the inclined surface illustrated in FIG. 9A. In this case, the detection position P1 of the ink sensor 104 and the detection position P2 of the ink sensor 105 are located at even greater differences in height in the vertical direction. Accordingly, the difference between the sensor dot count values SC1 and SC2 further increases and thus exceeds the threshold T2.

Suppose, in another instance, that the MFP 10 is placed on a horizontal surface, as illustrated in FIG. 4. If the ink sensor 104 or the ink sensor 105 is malfunctioning in this case, the sensor dot count value SC1 or the sensor dot count value SC2 becomes “0.” As the liquid surface level in the second reservoir 115 falls below the detection positions P1 and P2, the difference between the sensor dot count values SC1 and SC2 increases. In this case as well, the difference between the sensor dot count values SC1 and SC2 exceeds the threshold T2.

As a modification, in response to making a negative determination in S36 (S36: No), the controller 130 may optionally execute S38 (not shown), in which the controller 130 determines whether both the sensor dot count values SC1 and SC2 have remained substantially equal to “0” for more than a particular period of time. If this condition is satisfied (S38: Yes), the controller 130 may proceed to S39 (not shown) to cause the display 14 to display a message indicating that both the ink sensors 104 and 105 may be malfunctioning. Thereafter, the controller 130 may end the remaining amount determination control finalization process. Conversely, if the condition is not satisfied (S38: No), the controller 130 may end the remaining amount determination control finalization process without executing S39.

As illustrated in FIG. 6, after completing the remaining amount determination control finalization process (S13), the controller 130 proceeds to S14 to perform a remaining amount determination process.

### Remaining Amount Determination Process

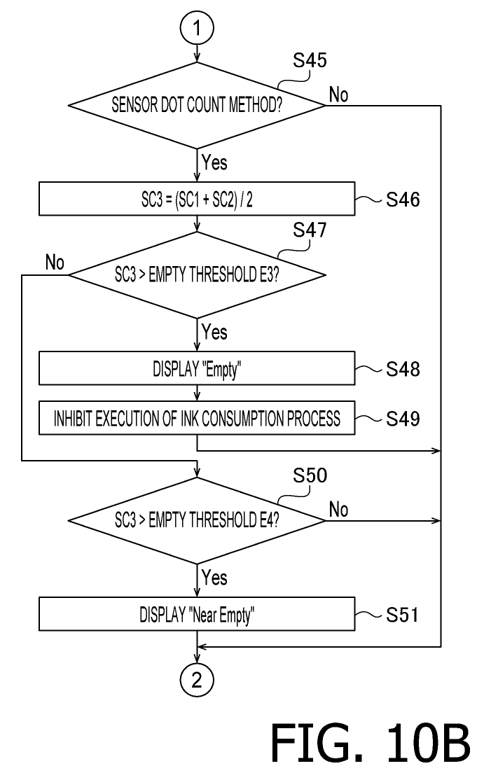

FIGS. 10A and 10B are flowcharts illustrating a procedure of the remaining amount determination process. As illustrated in FIGS. 10A and 10B, the controller 130 determines whether the finalized determination control is the total soft count method (S40). In response to determining that the finalized determination control is the total soft count method (S40: Yes), the controller 130 determines whether the total soft count value AC exceeds the empty threshold E1 (S41).

In response to determining that the total soft count value AC exceeds the empty threshold E1 (S41: Yes), the controller 130 causes the display 14 to display “Empty” (S42). This allows the user to recognize that no ink remains in the MFP 10. In this case, the controller 130 may inhibit execution of the ink consumption process. After executing S42, the controller 130 ends the remaining amount determination process.

In response to determining that the total soft count value AC is equal to or less than the empty threshold E1 (S41: No), the controller 130 determines whether the total soft count value AC exceeds the empty threshold E2 (S43). The empty threshold E2 is smaller than the empty threshold E1. Accordingly, the total soft count value AC reaches the empty threshold E2 before reaching the empty threshold E1.

In response to determining that the total soft count value AC exceeds the empty threshold E2 (S43: Yes), the controller 130 causes the display 14 to display “Near Empty” (S44). After executing S44, the controller 130 ends the remaining amount determination process. In response to determining that the total soft count value AC is equal to or less than the empty threshold E2 (S43: No), the controller 130 ends the remaining amount determination process.

In response to determining that the finalized determination control is not the total soft count method (S40: No), the controller 130 determines whether the finalized determination control is the sensor dot count method (S45). In response to determining that the finalized determination control is not the sensor dot count method (S45: No), the controller 130 ends the remaining amount determination process.

In response to determining that the finalized determination control is the sensor dot count method (S45: Yes), the controller 130 calculates a sensor dot count value SC3 (S46). The sensor dot count value SC3 is an average of the sensor dot count values SC1 and SC2.

The controller 130 determines whether the sensor dot count value SC3 exceeds the empty threshold E3 (S47). In response to determining that the sensor dot count value SC3 exceeds the empty threshold E3 (S47: Yes), the controller 130 causes the display 14 to display “Empty” (S48). This allows the user to recognize that no ink remains in the MFP 10. In addition, the controller 130 inhibits execution of the ink consumption process (S49). After executing S49, the controller 130 ends the remaining amount determination process.

In response to determining that the sensor dot count value SC3 is equal to or less than the empty threshold E3 (S47: No), the controller 130 determines whether the sensor dot count value SC3 exceeds the empty threshold E4 (S50). The empty threshold E4 is smaller than the empty threshold E3. Therefore, the sensor dot count value SC3 reaches the empty threshold E4 before reaching the empty threshold E3.

In response to determining that the sensor dot count value SC3 exceeds the empty threshold E4 (S50: Yes), the controller 130 causes the display 14 to display “Near Empty” (S51). After executing S51, the controller 130 ends the remaining amount determination process. In response to determining that the sensor dot count value SC3 is equal to or less than the empty threshold E4 (S50: No), the controller 130 ends the remaining amount determination process.

### Cartridge Replacement Process

As illustrated in FIG. 6, when the condition in S10 is not satisfied (S10: No), the controller proceeds to S15. Specifically, in response to determining that a command for an ink consumption process has not been received, the controller 130 proceeds to S15. Additionally, even when a command for an ink consumption process has been received, in response to determining that no ink remains in the ink cartridge 30, the controller 130 also proceeds to S15.

In S15, the controller 130 determines whether at least one of two conditions—i.e., a condition in which the cartridge replacement process is being executed or a condition in which a mounting checking timer is operating—is satisfied. In response to determining that the cartridge replacement process is being executed (S15: Yes), the controller 130 continues the cartridge replacement process (S16). In response to determining that the mounting checking timer is operating (S15: Yes), the controller 130 performs the cartridge replacement process (S16).

In response to determining that the cartridge replacement process is not being executed and that the mounting checking timer is not operating (S15: No), the controller 130 proceeds to S17 to perform other processes. The other processes are not particularly limited and refer to processes other than the processes described above. Examples of the other processes may include, but are not limited to, accepting user inputs.

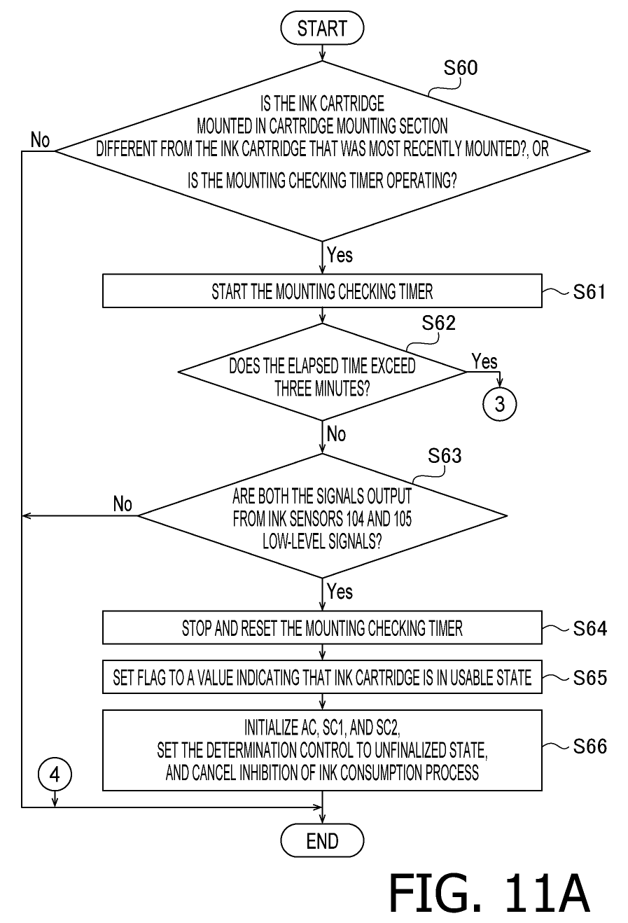

As illustrated in FIGS. 11A and 11B, the controller 130 determines whether at least one of two conditions—i.e., a condition in which the ink cartridge 30 mounted in the cartridge mounting section 110 is different from the ink cartridge 30 that was most recently mounted or a condition in which the mounting checking timer is operating—is satisfied (S60). In response to determining that none of the above two conditions is satisfied—i.e., when the ink cartridge 30 mounted in the cartridge mounting section 110 is the same as the ink cartridge 30 that was most recently mounted and the mounting checking timer is not operating (S60: No), the controller 130 ends the cartridge replacement process.

In response to determining that the ink cartridge 30 mounted in the cartridge mounting section 110 is different from the ink cartridge 30 that was most recently mounted and/or that the mounting checking timer is operating (S60: Yes), the controller 130 proceeds to S61. In S61, if the mounting checking timer is not operating, the controller 130 starts the mounting checking timer. The controller 130 counts the elapsed time from the start of the mounting checking timer. The elapsed time indicates the amount of time that has passed since the ink cartridge 30 was replaced.

The controller 130 determines whether the elapsed time exceeds three minutes (S62). In response to determining that the elapsed time is equal to or less than three minutes (S62: No), the controller 130 determines whether the signal output from the ink sensor 104 is a low-level signal and the signal output from the ink sensor 105 is a low-level signal (S63).

In response to determining that the signal output from the ink sensor 104 is a high-level signal (S63: No), the controller 130 ends the cartridge replacement process. In response to determining that the signal output from the ink sensor 105 is a high-level signal (S63: No), the controller 130 also ends the cartridge replacement process.

Suppose that the ink cartridge 30 is replaced while the liquid surface level in the second reservoir 115 is lower than the detection positions P1 and P2. In this case, ink flows from the first reservoir 80 of the newly mounted ink cartridge 30 into the second reservoir 115, thereby causing the liquid surface level in the second reservoir 115 to rise and then become higher than the detection positions P1 and P2. As a result, the signal output from the ink sensor 104 changes from a high-level signal to a low-level signal. The signal output from the ink sensor 105 also changes from a high-level signal to a low-level signal.

In response to determining that both the signal output from the ink sensor 104 and the signal output from the ink sensor 105 are low-level signals (S63: Yes), the controller 130 stops and resets the mounting checking timer (S64).

The controller 130 sets the flag indicating whether the ink cartridge 30 is in a usable state to “1” (S65). Thereafter, the controller 130 proceeds to S66 to configure the following settings. In S66, the controller 130 initializes the total soft count value AC to “0.” The controller 130 also initializes the sensor dot count values SC1 and SC2 to “0.” Furthermore, the controller 130 sets the determination control to an unfinalized state and cancels the inhibition of the ink consumption process. After S66, the controller 130 ends the cartridge replacement process.

In response to determining that the elapsed time exceeds three minutes (S62: Yes), the controller 130 stops and resets the mounting checking timer (S67). The controller 130 then sets the flag indicating whether the ink cartridge 30 is in a usable state to “0” (S68).

In S69, the controller 130 causes the display 14 to display a message such as “Ink cartridge replacement has failed. Please check the remaining amount of ink in the cartridge.” This allows the user to recognize that the ink cartridge replacement has failed.

The controller 130 determines whether only one of the signals output from the ink sensor 104 and the ink sensor 105 is a high-level signal (S70). In response to determining that this condition is not satisfied (i.e., either both signals are high-level or both are not) (S70: No), the controller 130 ends the cartridge replacement process.

For instance, as illustrated in FIG. 9A, suppose that the MFP 10 is placed on a noticeably inclined surface. In FIG. 9A, the detection position P1 of the ink sensor 104 and the detection position P2 of the ink sensor 105 are located at significantly different vertical positions. As the liquid surface level in the second reservoir 115 rises, the signal output from the ink sensor 104 changes from a high-level signal to a low-level signal. The signal output from the ink sensor 105 also changes from a high-level signal to a low-level signal. In this state, the timing at which the signal output from the ink sensor 104 changes from a high-level signal to a low-level signal differs significantly from the timing at which the signal output from the ink sensor 105 changes from a high-level signal to a low-level signal. Therefore, a state occurs in which only the signal output from the ink sensor 104 is a high-level signal or only the signal output from the ink sensor 105 is a high-level signal.

In another instance, as illustrated in FIG. 4, suppose that the MFP 10 is placed on a horizontal surface. In this case, if only the ink sensor 104 is malfunctioning, only the signal output from the ink sensor 104 is a high-level signal. Conversely, if only the ink sensor 105 is malfunctioning, only the signal output from the ink sensor 105 is a high-level signal.

In response to determining that only the signal output from the ink sensor 104 is a high-level signal or only the signal output from the ink sensor 105 is a high-level signal (S70: Yes), the controller 130 proceeds to S71 to cause the display 14 to display a message such as “Since the posture of the MFP 10 is inclined, please place the MFP 10 on a horizontal surface. If the MFP 10 is already placed on a horizontal surface, a remaining ink amount sensor may be malfunctioning.” This allows the user to recognize that the MFP 10 may be placed on a noticeably inclined surface or that a remaining ink amount sensor may be malfunctioning. After executing S71, the controller 130 ends the cartridge replacement process.

As a modification, in response to making a negative determination in S70 (S70: No), the controller 130 may optionally execute S72 (not shown), in which the controller 130 determines whether both the signal output from the ink sensor 104 and the signal output from the ink sensor 105 are high-level signals. If this condition is satisfied (S72: Yes), the controller 130 may proceed to S73 (not shown) to cause the display 14 to show a message indicating that both the ink sensors 104 and 105 may be malfunctioning. Thereafter, the controller 130 may end the cartridge replacement process. Conversely, if the condition is not satisfied (S72: No), the controller 130 may end the cartridge replacement process without executing S73.

### Operations and Advantageous Effects of Illustrative Embodiment

Suppose that the MFP 10 is placed on a horizontal surface or on a slightly inclined surface. In this state, when both the ink sensor 104 and the ink sensor 105 operate normally, a particular difference value—based on the difference between the timing at which the signal from the ink sensor 104 changes from a low-level signal to a high-level signal and the timing at which the signal from the ink sensor 105 changes from a low-level signal to a high-level signal—is less than the threshold T1. If this particular difference value (e.g., the difference between the sensor dot count values SC1 and SC2) exceeds the threshold T1, the controller 130 causes the display 14 to display a message indicating that the posture of the MFP 10 is inclined.

The message displayed on the display 14 notifies the user that the MFP 10 is placed on a noticeably inclined surface to such an extent that continuing substantially the same operations as when the MFP 10 is placed on a horizontal surface or on a slightly inclined surface is inappropriate. The message displayed on the display 14 also notifies the user, for instance, that the amount of ink stored in the second reservoir 115—determined by the total soft count method as the determination control—is low.

While aspects of the present disclosure have been described in conjunction with various example structures outlined above and illustrated in the drawings, various alternatives, modifications, variations, improvements, and/or substantial equivalents, whether known or that may be presently unforeseen, may become apparent to those having at least ordinary skill in the art. Accordingly, the example embodiment(s), as set forth above, are intended to be illustrative of the technical concepts according to aspects of the present disclosure, and not limiting the technical concepts. Various changes may be made without departing from the spirit and scope of the technical concepts according to aspects of the present disclosure. Therefore, the disclosure is intended to embrace all known or later developed alternatives, modifications, variations, improvements, and/or substantial equivalents. Some specific examples of potential modifications according to aspects of the present disclosure are provided below.

### First Modification

In the aforementioned illustrative embodiment, when the remaining amount determination process is performed using the sensor dot count method, the controller 130 determines the remaining amount of ink in the second reservoir 115 based on the sensor dot count value SC3, which is the average of the sensor dot count values SC1 and SC2. In another instance, the controller 130 may determine the remaining amount of ink in the second reservoir 115 based on only one of the sensor dot count value SC1 or the sensor dot count value SC2.

For instance, the controller 130 may cause the display 14 to display “Empty” in response to the sensor dot count value SC1 exceeding the empty threshold E3 or the sensor dot count value SC2 exceeding the empty threshold E3. Further, the controller 130 may cause the display 14 to display “Near Empty” in response to the sensor dot count value SC1 exceeding the empty threshold E4 or the sensor dot count value SC2 exceeding the empty threshold E4.

### Second Modification

In the aforementioned illustrative embodiment, the controller 130 determines the difference between the timing at which the signal output from the ink sensor 104 changes from a low-level signal to a high-level signal and the timing at which the signal output from the ink sensor 105 changes from a low-level signal to a high-level signal, based on the difference between the sensor dot count values SC1 and SC2. In another instance, the controller 130 may determine whether the signal output from the ink sensor 105 changes from a low-level signal to a high-level signal within a predetermined elapsed time from the timing at which the signal output from the ink sensor 104 changes from a low-level signal to a high-level signal. In this case, the controller 130 may also determine whether the signal output from the ink sensor 104 changes from a low-level signal to a high-level signal within a predetermined elapsed time from the timing at which the signal output from the ink sensor 105 changes from a low-level signal to a high-level signal.

### Third Modification

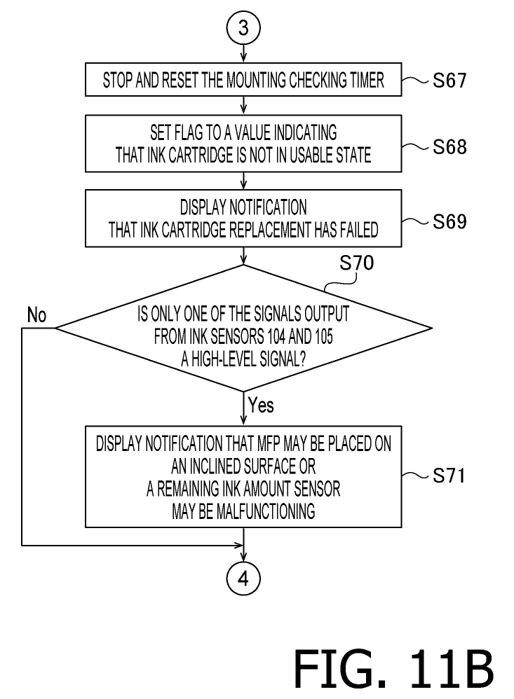

In the aforementioned illustrative embodiment, as illustrated in FIG. 4, the ink sensor 104 and the ink sensor 105 are located at substantially the same vertical position in the tank 103. In another instance, as illustrated in FIG. 12, the ink sensor 104 and the ink sensor 105 may be located at different vertical positions in the tank 103. In FIG. 12, a detection position P1 of the ink sensor 104 is located above a detection position P2 of the ink sensor 105.

In the third modification, as illustrated in FIG. 12, suppose that the MFP 10 is placed on a horizontal surface or on a slightly inclined surface. In this case, the difference between sensor dot count values SC1 and SC2 falls within a predetermined range. The upper limit of the predetermined range is a threshold T1. The lower limit of the predetermined range is a threshold T3.

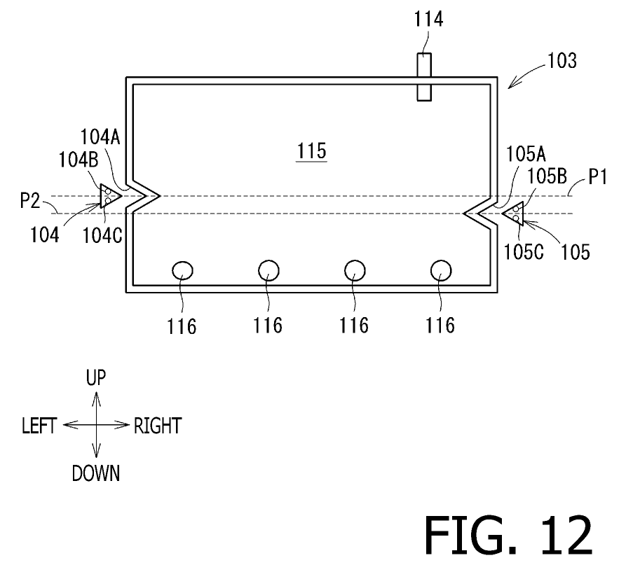

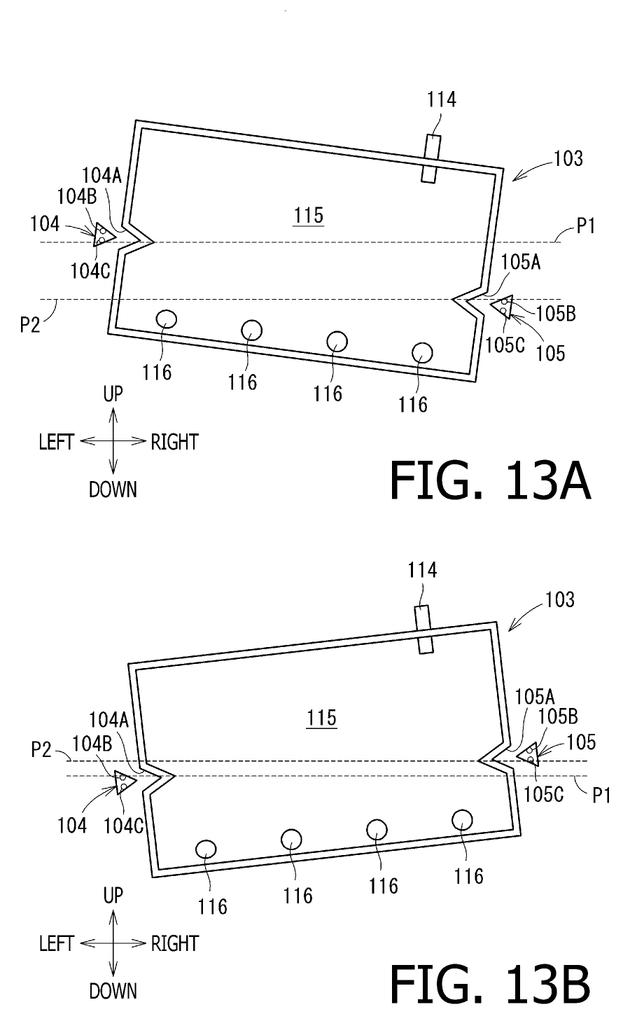

As illustrated in FIG. 13A, suppose that the MFP 10 is placed on a noticeably inclined surface on which a right end of the tank 103 is lower than a left end thereof. In this case, the difference between the sensor dot count values SC1 and SC2 exceeds the threshold T1. In this case, during the remaining amount determination control finalization process, the controller 130 causes the display 14 to display a message such as “Since the posture of the MFP 10 is inclined, please place the MFP 10 on a horizontal surface.”

As illustrated in FIG. 13B, suppose that the MFP 10 is placed on a noticeably inclined surface on which the left end of the tank 103 is lower than the right end thereof. In this case, the difference between the sensor dot count values SC1 and SC2 is less than the threshold T3. In this case, during the remaining amount determination control finalization process, the controller 130 causes the display 14 to display a message such as “Since the posture of the MFP 10 is inclined, please place the MFP 10 on a horizontal surface.”

### Other Modifications

In the MFP 10 of the aforementioned illustrative embodiment, the detection positions P1 and P2 are spaced apart from each other in the left-right direction of the tank 103. In another instance, the detection positions P1 and P2 may be spaced apart from each other in the front-rear direction. Further, the detection positions P1 and P2 may be spaced apart from each other in both the left-right direction and the front-rear direction.

In the MFP 10 of the aforementioned illustrative embodiment, the tank 103 has four outlets 116 that are open into the second reservoir 115. However, the number of the outlets 116 is not limited to four. When a plurality of outlets 116 are open into the second reservoir 115, the direction in which the outlets 116 are arranged may not necessarily be the left-right direction. Further, the direction in which the plurality of outlets 116 are arranged may not necessarily be the same as the direction in which the ink sensors 104 and 105 are arranged.

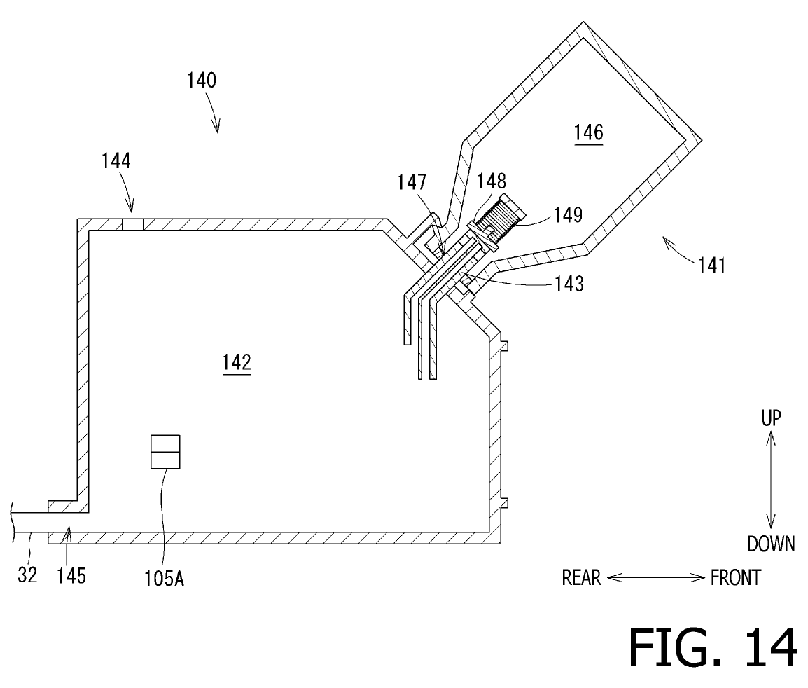

In the MFP 10, the tank 103 is configured to receive an ink cartridge 30 connected thereto. However, the tank 103 may instead be configured to receive an ink bottle 141 connected thereto. For instance, as illustrated in FIG. 14, ink may be supplied from the ink bottle 141 to a tank 140 that is fixed to the MFP 10. The tank 140 may have a box shape. An internal space of the tank 140 may serve as a reservoir 142. The reservoir 142 may be configured to store ink. The tank 140 may have an ink needle 143 that protrudes outward. The ink needle 143 may be a tubular member having two flow paths, i.e., a gas flow path and a liquid flow path. The gas flow path and the liquid flow path of the ink needle 143 may communicate the reservoir 142 with the outside of the tank 140.

The tank 140 may have an atmosphere communication port 144. The reservoir 142 may communicate with the outside through the atmosphere communication port 144. The tank 140 may have four outlets 145. Although FIG. 14 illustrates one outlet 145, four outlets 145 may be disposed apart from each other in the left-right direction. The four outlets 145 may be connected to four ink tubes 32, respectively. It is noted that the left-right direction is perpendicular to the plane of FIG. 14.

An internal space of the bottle 141 may serve as a reservoir 146. The bottle 141 may have an opening 147. Through the opening 147, the reservoir 146 may communicate with the outside. The opening 147 may be closed by a valve 148 that is urged by a spring 149. When the ink needle 143 enters the opening 147, the valve 148 may be moved away from the opening 147 against the urging force of the spring 149. Through the ink needle 143, ink flows out from the reservoir 146 into the reservoir 142 by gas-liquid replacement. In the tank 140 configured as described above, the ink sensors 104 and 105 may be provided in substantially the same manner as in the aforementioned illustrative embodiment. It is noted that the opening 147 may be closed not by the valve 148 urged by the spring 149 but by a valve attached to the opening 147 and having a slit through which the ink needle 143 may pass.

In the MFP 10, the inflow of ink from the ink cartridge 30 to the tank 103 is not limited to a liquid surface level difference. For instance, the tank 103 may be disposed below the ink cartridge 30, and the ink cartridge 30 and the tank 103 may be connected to each other through a liquid flow path and a gas flow path. In this case, the ink cartridge 30 is not in communication with the atmosphere. Ink flows from the ink cartridge 30 to the tank 103 by gas-liquid replacement between the ink cartridge 30 and the tank 103. Such a system is generally referred to as a chicken feed system. Further, the tank 103 may be omitted, and only the ink cartridge 30 may be provided. In this case, the ink cartridge 30 includes a supply port 93 positioned lower than the detection positions P1 and P2.

In the MFP 10 of the aforementioned illustrative embodiment, the plurality of outlets 116 are disposed in a rear wall of the tank 103 (more specifically, the four outlets 116 are disposed in the rear surface of the second reservoir 115). However, the plurality of outlets 116 may be disposed in a wall other than the rear wall of the tank 103, provided that they are positioned lower than the detection positions P1 and P2 in the vertical direction. For instance, the plurality of outlets 116 may be disposed in a front wall, a right wall, a left wall, or a bottom wall of the tank 103.

In the MFP 10 of the aforementioned illustrative embodiment, the controller 130 causes the display 14 to display messages. However, feasible configurations are not limited thereto as long as the controller 130 is enabled to provide notifications to the user. For instance, the controller 130 may cause a notification device, instead of the display 14, to output different types of buzzer sounds or different types of lights.

In the MFP 10 of the aforementioned illustrative embodiment, the ink sensors 104 and 105 are prism-type photo sensors. However, the ink sensors 104 and 105 are not limited thereto as long as the light-receiving elements 104C and 105C are enabled to output different electrical signals depending on whether they receive light emitted from the light-emitting elements 104B and 105B, respectively. Feasible examples of the ink sensors 104 and 105 may include, but are not limited to, transmissive photo sensors, separate-type photo sensors, reflective photo sensors, and actuator-type photo sensors. Feasible examples of the ink sensors 104 and 105 may further include, but are not limited to, water level sensors using three electrode rods. In this case, for instance, the three electrode rods may be disposed apart from each other in the front-rear direction in the second reservoir 115. The three electrode rods may be connected to one or more electric circuits in such a manner that different electrical signals are output depending on whether two of the three electrode rods are in contact with ink.

The following provides examples of associations between elements set forth in the aforementioned illustrative embodiment(s) and modification(s), and elements claimed according to aspects of the present disclosure. For instance, the MFP 10 may be an example of a “liquid consumption device” according to aspects of the present disclosure. The tank 103 and the tank 140 may be included as examples of a “liquid container” according to aspects of the present disclosure. The second reservoir 115 of the tank 103 and the reservoir 142 of the tank 140 may be included as examples of a “reservoir” according to aspects of the present disclosure. The opening 117 of the ink needle 102 and the liquid flow path of the ink needle 143 may be included as examples of an “inlet” according to aspects of the present disclosure. The outlets 116 and the outlets 145 may be included as examples of an “outlet” according to aspects of the present disclosure. The print engine 24 may be an example of a “liquid consumption device” according to aspects of the present disclosure. The ink sensor 104 may be an example of a “first sensor” according to aspects of the present disclosure. The ink sensor 105 may be an example of a “second sensor” according to aspects of the present disclosure. The display 14 may be an example of a “notification device” according to aspects of the present disclosure. The controller 130 may be an example of a “controller” according to aspects of the present disclosure.

What is claimed is:

1. A liquid consumption apparatus comprising:
a liquid container having a reservoir configured to store liquid;
an inlet that is open into the reservoir;
an outlet that is open into the reservoir;
a liquid consumption device configured to consume the liquid supplied through the outlet;
a first sensor configured to detect the liquid stored in the reservoir;
a second sensor configured to detect the liquid stored in the reservoir;
a notification device; and
a controller configured to cause the notification device to provide a particular notification in response to determining that a difference between a first value based on a change in a signal output from the first sensor and a second value based on a change in a signal output from the second sensor is outside a particular range.

2. The liquid consumption apparatus according to claim 1,
wherein the first sensor is configured to output a first signal when detecting liquid and to output a second signal when not detecting liquid,
wherein the second sensor is configured to output a third signal when detecting liquid and to output a fourth signal when not detecting liquid, and
wherein the controller is further configured to cause the notification device to provide the particular notification in response to determining that the difference between the first value based on a first timing at which the signal output from the first sensor changes from the first signal to the second signal and the second value based on a second timing at which the signal output from the second sensor changes from the third signal to the fourth signal is outside the particular range.

3. The liquid consumption apparatus according to claim 2,
wherein the controller is further configured to cause the notification device to provide the particular notification in response to determining that an estimated amount of the liquid consumed by the liquid consumption device from the first timing to the second timing is outside the particular range.

4. The liquid consumption apparatus according to claim 2,
wherein the particular range is defined as a range equal to or less than a first threshold, and
wherein the controller is further configured to cause the notification device to provide a first notification as the particular notification in response to determining that the difference between the first value and the second value exceeds the first threshold.

5. The liquid consumption apparatus according to claim 4,
wherein the first notification contains information indicating that the liquid consumption apparatus is placed in an inclined posture.

6. The liquid consumption apparatus according to claim 4,
wherein the controller is further configured to cause the notification device to provide, as the particular notification, a second notification different from the first notification, in response to determining that the difference between the first value and the second value exceeds a second threshold greater than the first threshold.

7. The liquid consumption apparatus according to claim 6,
wherein the second notification contains information indicating that at least one of the first sensor or the second sensor is malfunctioning.

8. The liquid consumption apparatus according to claim 4,
wherein the particular range is defined as a range from a second threshold to the first threshold, inclusive, the second threshold being less than the first threshold, and
wherein the controller is further configured to cause the notification device to provide the first notification as the particular notification in response to determining that the difference between the first value and the second value is less than the second threshold.

9. The liquid consumption apparatus according to claim 2,
wherein the controller is further configured to:
perform a first remaining amount determination process to determine a remaining amount of the liquid stored in the reservoir, in response to determining that the difference between the first value and the second value is outside the particular range; and
perform a second remaining amount determination process to determine the remaining amount of the liquid stored in the reservoir using a method different from the first remaining amount determination process, in response to determining that the difference between the first value and the second value is within the particular range.

10. The liquid consumption apparatus according to claim 9,
wherein the controller is further configured to determine, in the second remaining amount determination process, the remaining amount of the liquid stored in the reservoir based on an estimated amount of the liquid consumed by the liquid consumption device from at least one of the first timing or the second timing.

11. The liquid consumption apparatus according to claim 10,
wherein the controller is further configured to cause, in the second remaining amount determination process, the notification device to provide a notification that the remaining amount of the liquid stored in the reservoir is low, in response to determining that an average of the first value and the second value exceeds a particular threshold,
wherein the first value is determined based on the estimated amount of the liquid consumed by the liquid consumption device from the first timing,
wherein the second value is determined based on the estimated amount of the liquid consumed by the liquid consumption device from the second timing, and
wherein the average of the first value and the second value has a negative correlation with the remaining amount of the liquid stored in the reservoir, thereby representing how low the remaining amount of the liquid stored in the reservoir is.

12. The liquid consumption apparatus according to claim 11,
wherein the controller is further configured to inhibit, in the second remaining amount determination process, consumption of the liquid by the liquid consumption device in response to determining that the average of the first value and the second value exceeds the particular threshold.

13. The liquid consumption apparatus according to claim 9,
wherein the controller is further configured to determine, in the first remaining amount determination process, the remaining amount of the liquid stored in the reservoir based on an estimated amount of the liquid consumed by the liquid consumption device after acquiring a signal indicating that liquid has flowed into the reservoir.

14. The liquid consumption apparatus according to claim 13,
wherein the controller is further configured to cause, in the first remaining amount determination process, the notification device to provide. as the particular notification, information indicating that the remaining amount of the liquid stored in the reservoir is low, in response to determining that a third value exceeds a specific threshold, the third value being determined based on the estimated amount of the liquid consumed by the liquid consumption device after the acquisition of the signal indicating that liquid has flowed into the reservoir, and
wherein the third value has a negative correlation with the remaining amount of the liquid stored in the reservoir, thereby representing how low the remaining amount of the liquid stored in the reservoir is.

15. The liquid consumption apparatus according to claim 1,
wherein the first sensor is further configured to output a first signal when detecting the liquid stored in the reservoir and to output a second signal when not detecting the liquid,
wherein the second sensor is further configured to output a third signal when detecting the liquid stored in the reservoir and to output a fourth signal when not detecting the liquid, and
wherein the controller is further configured to cause the notification device to provide the particular notification in response to determining that an elapsed time from a first timing at which the signal output from the first sensor changes from the first signal to the second signal to a second timing at which the signal output from the second sensor changes from the third signal to the fourth signal exceeds a particular time.

16. The liquid consumption apparatus according to claim 1,
wherein the controller is further configured to cause the notification device to provide information indicating that at least one of the first sensor or the second sensor is malfunctioning in response to determining that the signal output from at least one of the first sensor or the second sensor has not changed when an elapsed time after acquiring a signal indicating that liquid has flowed into the reservoir exceeds a particular time.

17. The liquid consumption apparatus according to claim 1, further comprising a plurality of the outlets that are open into the reservoir.

18. The liquid consumption apparatus according to claim 17,
wherein the plurality of the outlets are arranged in a horizontal direction, and
wherein the first sensor and the second sensor are arranged in the horizontal direction.
